(19) United States
(12) Patent Application Publication
(10) Pub. No.: US 2024/0282085 A1
(43) Pub. Date: Aug. 22, 2024

(54) METHOD OF PRODUCING STORAGE MEDIUM STORING MACHINE LEARNING MODEL AND STORAGE MEDIUM STORING COMPUTER-READABLE INSTRUCTIONS FOR PERFORMING ANOMALY DETECTION IN OBJECT WITH MACHINE LEARNING MODEL

(71) Applicant: BROTHER KOGYO KABUSHIKI KAISHA, Nagoya (JP)

(72) Inventor: Masaki KONDO, Toyoake (JP)

(21) Appl. No.: 18/650,706

(22) Filed: Apr. 30, 2024

Related U.S. Application Data
(63) Continuation of application No. PCT/JP2022/039283, filed on Oct. 21, 2022.

(30) Foreign Application Priority Data
Nov. 1, 2021 (JP) 2021-178731
Jul. 1, 2022 (JP) 2022-107396

(51) Int. Cl. G06V 10/774; G06T 7/00; G06V 10/40; G06V 10/77; G06V 10/82

(52) U.S. Cl. CPC G06V 10/774; G06T 7/0002; G06V 10/40; G06V 10/7715; G06V 10/82; G06T 2207/20081; G06T 2207/20084; G06T 2207/30176

(57) ABSTRACT

A method of producing a non-transitory computer-readable storage medium storing a machine learning model is provided. The machine learning model is used for anomaly detection to detect an anomaly in an object. The machine learning model includes an encoder. The encoder is configured to generate feature data for the object in response to captured image data obtained by capturing an image of the object being inputted. The encoder includes a convolutional neural network. The method includes: training the encoder using training image data. The training image data is obtained by performing a specific image process on original image data. The original image data represents the image of the object and is used to create the object.

### REFERENCE TO RELATED APPLICATIONS

This is a by-pass continuation application of International Application No. PCT/JP2022/039283 filed on Oct. 21, 2022 which claims priorities from Japanese Patent Application No. 2021-178731 filed on Nov. 1, 2021 and Japanese Patent Application No. 2022-107396 filed on Jul. 1, 2022. The entire contents of the International Application and the priority applications are incorporated herein by reference.

### BACKGROUND ART

Anomaly detection using an image generation model, which is a machine learning model that generates image data, is known in the art. In one disclosed technology, a plurality of sets of captured image data obtained by photographing a normal product is inputted into a pre-trained CNN (convolutional neural network) to generate a feature map for each set of the captured image data. These feature maps are used to generate a matrix of Gaussian parameters representing features of the normal product. During inspection, captured images obtained by photographing products to be inspected are inputted into the CNN to generate feature maps, and feature vectors indicating features in each product under inspection are generated from the feature map. Anomalies are then detected in the product using the matrix for a normal product and the feature vectors of the product being inspected.

### SUMMARY

However, the above technology requires data for a large number of captured images. For example, captured image data for a large number of images of a normal product may be necessary to generate a matrix indicating features of the normal product. Moreover, when a CNN is trained using captured images of products, data for a large number of captured images of the products may be needed for training.

In view of the foregoing, it is an object of the present disclosure to provide a technology capable of reducing the amount of captured image data required to perform anomaly detection using a machine learning model.

In order to attain the above and other object, according to one aspect, the present disclosure provides a method of producing a non-transitory computer-readable storage medium storing a machine learning model. The machine learning model is used for anomaly detection to detect an anomaly in an object. The machine learning model includes an encoder. The encoder is configured to generate feature data for the object in response to captured image data obtained by capturing an image of the object being inputted. The encoder includes a convolutional neural network. The method includes: training the encoder using training image data. The training image data is obtained by performing a specific image process on original image data. The original image data represents the image of the object and is used to create the object.

With the above configuration, image data obtained by performing a specific image process on original image data used to create the object is used as training image data. As a result, a machine learning model is provided that can create enough captured image data required during training the machine learning model even when sufficient captured image data is not available to be inputted into the machine learning model. Hence, the number of sets of captured image data required for anomaly detection using a machine learning model can be reduced.

According to another aspect, the present disclosure provides a non-transitory computer-readable storage medium storing a set of computer-readable instructions for performing anomaly detection with a machine learning model. The anomaly detection detects an anomaly in an object including a normal object and an anomalous object containing the anomaly. The machine learning model includes an encoder. The encoder is configured to generate feature data for the object in response to captured image data obtained by capturing an image of the object being inputted. The encoder includes a convolutional neural network. The set of computer-readable instructions, when executed by a computer, causes the computer to perform: generating image data for feature extraction; generating feature data for the normal object; and detecting an anomaly in an inspection object. The generating image data for feature extraction is performed by executing a first adjustment process on original image data. The original image data represents an image of the object and is used to create the object. The image data for feature extraction represents an image of the normal object. The generating feature data for the normal object is performed by inputting the image data for feature extraction into the machine learning model that has been trained. The detecting an anomaly in an inspection object is performed using the feature data for the normal object and feature data for the inspection object.

With the above configuration, image data obtained by executing a first adjustment process on original image data used to create an object is used as image data for feature extraction. As a result, the computer can generate feature data for a normal object even when sufficient captured image data is not available. Therefore, this configuration can reduce the number of sets of captured image data required for detecting anomalies with a machine learning model.

According to still another aspect, the present disclosure also provides a method of detecting an anomaly in an object with a machine learning model. The object includes a normal object and an anomalous object containing the anomaly. The machine learning model includes an encoder. The encoder is configured to generate feature data for the object in response to captured image data obtained by capturing an image of the object being inputted. The encoder includes a convolutional neural network. The method includes: training; generating; and detecting. The training trains the encoder using training image data. The generating generates feature data for the normal object by inputting image data for feature extraction into the encoder trained in the training. The detecting detects an anomaly in an inspection object using the feature data for the normal object and feature data for the inspection object. At least one of the training image data and the image data for feature extraction is obtained by executing a specific process on original image data. The original image data represents an image of the object and is used to create the object.

According to still another aspect, the present disclosure further provides a method of producing a non-transitory computer-readable storage medium storing a machine learning model. The machine learning model is used for anomaly detection detecting an anomaly in an object including a normal object and an anomalous object containing the anomaly. The machine learning model includes an encoder. The encoder is configured to generated feature data for the object in response to captured image data obtained by capturing an image of the object being inputted. The encoder includes a convolutional neural network. The method includes: training. The training trains the encoder using training image data. The training image data is obtained by performing a specific image process on original image data. The original image data is obtained by capturing an image of the object. The anomaly detection includes: generating image data for feature extraction; generating feature data for the normal object; and detecting an anomaly in an inspection object. The generating image data for feature extraction is performed by executing a first adjustment process on the original image data. The image data for feature extraction represents an image of the normal object. The generating feature data for the normal object is performed by inputting the image data for feature extraction into the machine learning model that has been trained. The detecting an anomaly in an inspection object is performed using the feature data for the normal object and feature data for the inspection object.

With the above configuration, image data obtained by performing a specific image process on original image data obtained by capturing an image of an object is used as training image data. As a result, a machine learning model is provided that can create enough captured image data required during training the machine learning model even when sufficient captured image data is not available to be inputted into the machine learning model. In addition, image data obtained by executing a first adjustment process on the original image data obtained by capturing the image of the object is used as image data for feature extraction. As a result, feature data for a normal object can be generated even when sufficient captured image data is not available. Therefore, the number of sets of captured image data required for anomaly detection using a machine learning model can be reduced.

According to still another aspect, the present disclosure also provides a non-transitory computer-readable storage medium storing a set of computer-readable instructions for performing anomaly detection with a machine learning model. The anomaly detection detects an anomaly in an object including a normal object and an anomalous object containing the anomaly. The machine learning model includes an encoder. The encoder is configured to generate feature data for the object in response to captured image data obtained by capturing an image of the object being inputted. The encoder includes a convolutional neural network. The set of computer-readable instructions, when executed by a computer, causes the computer to perform: generating image data for feature extraction; generating feature data for the normal object; and detecting an anomaly in an inspection object. The generating image data for feature extraction is performed by executing a first adjustment process on original image data. The original image data is obtained by capturing an image of the object. The image data for feature extraction represents an image of the normal object. The generating feature data for the normal object is performed by inputting the image data for feature extraction into the machine learning model that has been trained. The detecting an anomaly in an inspection object is performed using the feature data for the normal object and feature data for the inspection object.

With the above configuration, image data obtained by executing a first adjustment process on original image data obtained by capturing an image of an object is used as image data for feature extraction. As a result, the computer can generate feature data for a normal object even when sufficient captured image data is not available. Therefore, this configuration can reduce the number of sets of captured image data required for detecting anomalies with a machine learning model.

According to still another aspect, the present disclosure further provides a method of detecting anomaly in an object with a machine learning model. The object includes a normal object and an anomalous object containing the anomaly. The machine learning model includes an encoder. The encoder is configured to generate feature data for the object in response to captured image data obtained by capturing an image of the object being inputted. The encoder includes a convolutional neural network. The method includes: training; generating; and detecting. The training trains the encoder using training image data. The generating generates feature data for the normal object by inputting image data for feature extraction into the encoder trained in the training. The detecting detects an anomaly in an inspection object using the feature data for the normal object and feature data for the inspection object. At least one of the training image data and the image data for feature extraction is obtained by executing a specific process on original image data. The original image data is obtained by capturing an image of the object.

The technology disclosed in this specification can be realized in various other forms of, for example, a method of training a machine learning model, an inspection device, an inspection method, computer programs designed to realize these devices and methods, and a storage medium storing these computer programs.

### BRIEF DESCRIPTION OF DRAWINGS

FIG. 1 is a block diagram illustrating the configuration of an inspection system including an inspection device and an imaging device.

FIGS. 2A and 2B are explanatory diagrams of a product, in which: FIG. 2A is a perspective view of the product, and FIG. 2B illustrates a label affixed to the product illustrated in FIG. 2A.

FIGS. 3A through 3D are explanatory diagrams illustrating an inspection preparation process performed using a machine learning model, in which: FIG. 3A is a schematic diagram illustrating the configuration of the machine learning model; FIG. 3B conceptually illustrates feature extraction for a normal article; FIG. 3C illustrates effective maps selected from feature maps illustrated in FIG. 3B; and FIG. 3D illustrates a feature matrix FM for a normal image generated using the effective maps illustrated in FIG. 3C.

FIGS. 4A through 4E are explanatory diagrams illustrating sample images, in which: FIG. 4A illustrates an example of a captured image represented by captured image data; FIG. 4B illustrates an example of a document image represented by document image data; FIG. 4C illustrates an example of a normal image represented by normal image data; FIG. 4D illustrates an example of an anomalous image represented by anomalous image data; and FIG. 4E illustrates an example of an anomaly map.

FIG. 5 is a flowchart illustrating steps in the inspection preparation process.

FIG. 6 is a flowchart illustrating steps in a normal image data generation process.

FIG. 7 is a flowchart illustrating steps in an anomalous image data generation process.

FIG. 8 is a flowchart illustrating steps in a training process.

FIGS. 9A through 9D are explanatory diagrams illustrating matrices and maps, in which: FIG. 9A illustrates feature matrices for normal images; FIG. 9B illustrates a Gaussian matrix for a normal article; FIG. 9C illustrates a feature matrix for an inspection article; and FIG. 9D illustrates an anomaly map.

FIG. 10 is a flowchart illustrating steps in an inspection process.

FIG. 11 is a schematic diagram illustrating the configuration of a machine learning model.

FIG. 12 is a flowchart illustrating steps in an inspection preparation process.

### DESCRIPTION

### A. First Embodiment

### A-1. Configuration of Inspection Device

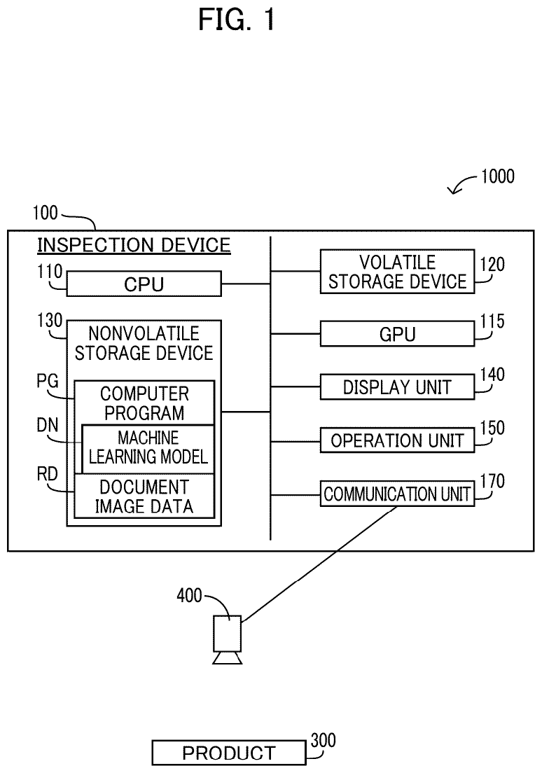

Hereinafter, one embodiment of the present disclosure will be described while referring to the accompanying drawings. FIG. 1 is a block diagram illustrating the configuration of an inspection system 1000 according to the present embodiment. The inspection system 1000 includes an inspection device 100 and an imaging device 400. The inspection device 100 and imaging device 400 are connected and capable of communicating with each other.

The inspection device 100 is a personal computer or other computer. The inspection device 100 is provided with a CPU 110 as a controller of the inspection device 100, a graphics processing unit (GPU) 115, a volatile storage device 120 such as RAM, a nonvolatile storage device 130 such as a hard disk drive, an operation unit 150 such as a mouse and a keyboard, a display unit 140 such as a liquid crystal display, and a communication unit 170. The communication unit 170 includes a wired or wireless interface for connecting to and communicating with an external device such as the imaging device 400.

The GPU 115 is a processor that performs computational processes for the image processing of three-dimensional graphics or the like under control of the CPU 110. In the present embodiment, the GPU 115 is used for performing the calculations of a machine learning model DN described later.

The volatile storage device 120 provides a buffer area for temporarily storing various intermediate data generated when the CPU 110 executes processes. The nonvolatile storage device 130 stores a computer program PG for the inspection device 100, and document image data RD. The document image data RD will be described later.

The computer program PG includes a computer program module that allows the CPU 110 and GPU 115 to implement functions of the machine learning model DN described later in cooperation with each other. The computer program PG is provided by the manufacturer of the inspection device 100, for example. The computer program PG may be downloaded from a server or may be recorded on a DVD-ROM or other storage medium and supplied in this form, for example. By executing the computer program PG, the CPU 110 implements an inspection process or a training process described later.

The imaging device 400 is a digital camera that generates image data representing a subject (hereinafter called “captured image data”) by optically capturing an image of the subject. The captured image data is bitmap data that represents an image including a plurality of pixels, and specifically is RGB image data representing the color of each pixel in RGB values. RGB values are gradation values for three color components (hereinafter called “component values”), i.e., color values of the RGB color system, which includes R values, G values, and B values. The R, G, and B values each takes on one of a prescribed number of gradations (256, for example). The captured image data may also be luminance image data representing the luminance of each pixel.

Under control of the inspection device 100, the imaging device 400 generates captured image data and transmits this image data to the inspection device 100. In the present embodiment, the imaging device 400 is used to capture the image of a product 300 and to generate captured image data representing the captured image. A label L, which is the object of the inspection process, is affixed to the product 300.

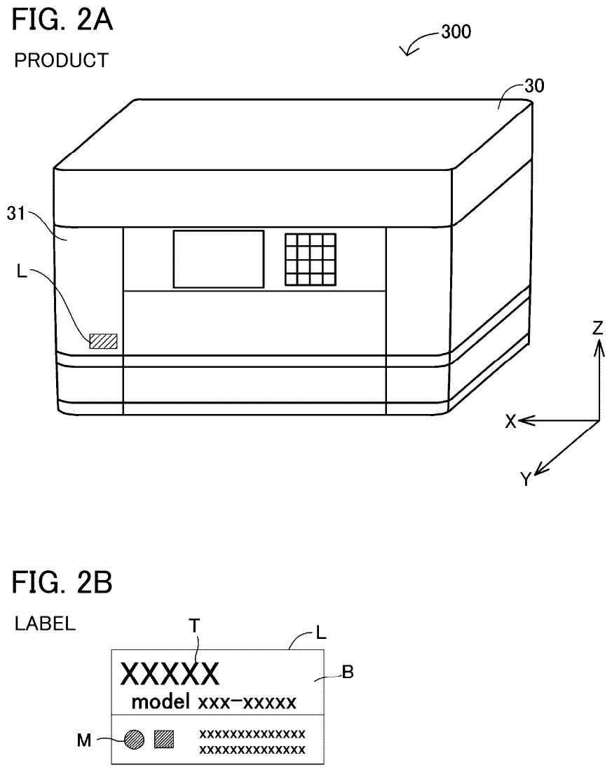

FIGS. 2A and 2B are explanatory diagrams of the product 300. FIG. 2A is a perspective view of the product 300. In the present embodiment, the product 300 is a printer having a housing 30 with a general rectangular parallelepiped shape. During the manufacturing process, a rectangular label L is affixed to a predetermined affixing position on a front surface 31 (the surface on the +Y side) of the housing 30.

FIG. 2B illustrates the label L. In this example, the label L includes a background B, and characters T and marks M representing a brand logo, a model number, a lot number, and various other information of the product 300 and manufacturer thereof.

### A-2. Configuration of Machine Learning Model DN

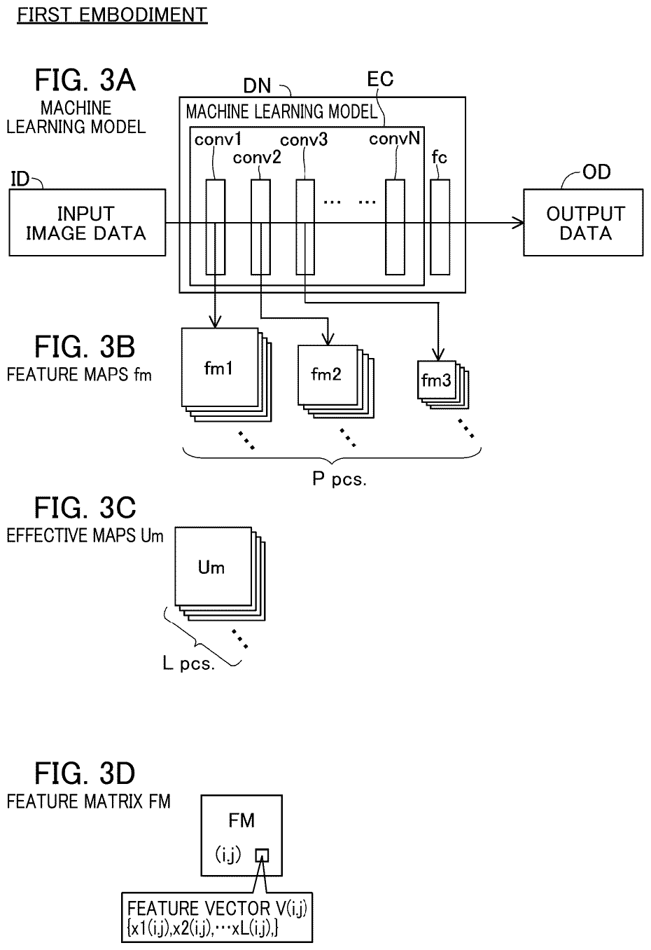

Next, the configuration of a machine learning model DN will be described. FIG. 3A is a diagram illustrating the configuration of the machine learning model DN in the first embodiment. The machine learning model DN performs arithmetic processes on input image data ID using a plurality of calculation parameters to generate output data OD corresponding to the input image data ID.

The machine learning model DN is an image recognition model that generates output data indicating the results of image recognition. The machine learning model DN includes an encoder EC, and a classifier fc. The encoder EC performs dimensionality reduction on the input image data ID to extract features of the image represented by the inputted image data ID. The encoder EC is a Convolutional Neural Network (CNN) that contains N convolutional layers conv1-convN (where N is an integer greater than or equal to two). Each convolutional layer performs convolution using a filter of a predetermined size to generate feature maps. The output values of each convolution are values transformed by inputting the input image data ID to which biases are added into a prescribed activation function. The feature maps outputted from each convolutional layer are inputted into the next layer (another convolutional layer or a fully-connected layer of the classifier fc). A well-known function such as a rectified linear unit (ReLU) is used as the activation function.

The classifier fc includes one or more fully-connected layers. The classifier fc reduces the number of dimensions in each feature map outputted from the encoder EC to produce a set of output data OD.

The filter weights and biases used in the convolutions described above and the weights and biases used for operations of fully-connected layers in the classifier fc are calculation parameters that are adjusted through a training process described later.

The well-known model called ResNet (Residual Network) is used as the machine learning model DN in the present embodiment. This model is described by K. He, X. Zhang, S. Ren, and J. Sun in the paper “Deep Residual Learning for Image Recognition” (ICML 2016), for example.

The input image data ID in the present embodiment is image data representing a rectangular image having a predetermined size, such as several hundred pixels×several hundred pixels. The input image data ID is bitmap data representing an image that contains a plurality of pixels, and specifically RGB image data. As will be described later, the input image data ID of the present embodiment is assumed to be captured image data representing a captured image containing an image of the label L described above.

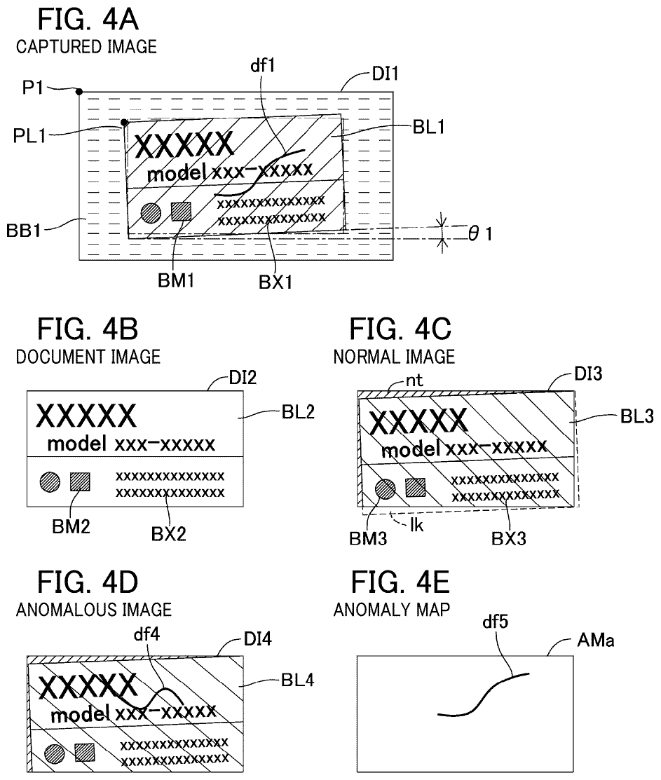

FIGS. 4A through 4E are explanatory diagrams illustrating sample images used in the present embodiment. FIG. 4A illustrates an example of a captured image DI1 represented by captured image data. The captured image DI1 includes a background BB1 corresponding to an image representing an area other than the label L and a label BL1 corresponding to an image representing an image of the label L. The label shown in the captured image DI1 is given the reference number BL1 to distinguish this label from the actual label L. Specifically, in the present embodiment, elements with the reference numbers beginning with B and containing multiple characters or numbers represent images even though they are not explicitly described. The background BB1 of the label BL1 represents the front surface 31 of the housing 30 constituting the product 300.

The label BL1 in the captured image DI1 includes characters BX1, and marks BM1. The position and angle of the label BL1 in the captured image DI1 will vary. The position of an upper-left vertex PL1 of the label BL1 relative to an upper-left vertex P1 of the captured image DI1 can vary due to variations in the affixed position of the label L on the product 300 whose image is being captured and variations in the position of the product 300 relative to the imaging device 400, for example. Similarly, variation in an angle θ1 between an extending direction of the bottom edge of the captured image DI1 and an extending direction of the bottom edge of the label BL1 may occur.

Additionally, the colors of the label BL1 in the captured image DI1 may differ from the colors of the actual label L and a label BL3 in the document image to be described later due to the brightness of illumination and other imaging conditions. The colors of the label BL1 may also vary among the captured images. Similarly, the color of the background BB1 in the captured image DI1 can vary among the captured images. Moreover, since the captured image DI1 is generated using an image sensor, the captured image DI1 contains blur and noise not included in the actual label L or the document image described later. Such blur and noise also produce variations in the captured images.

Further, since the actual label L whose image is being captured can contain various defects, such as scratches, stains, and missing pieces, the label BL1 of the captured image DI1 may also contain these defects. In the example of FIG. 4A, the label BL1 includes a scratch df1.

The output data OD indicates the recognition result for recognizing the type of subject in the image (the captured image in the present embodiment) represented by the input image data ID. As will be described later, the machine learning model DN according to the present embodiment is trained to discriminate whether the label in a captured image is an anomalous article containing defects or a normal article containing no defects. Thus, the output data OD indicates the identification result, i.e., whether the label in the captured image is an anomalous article or a normal article.

### A-3. Inspection Preparation Process

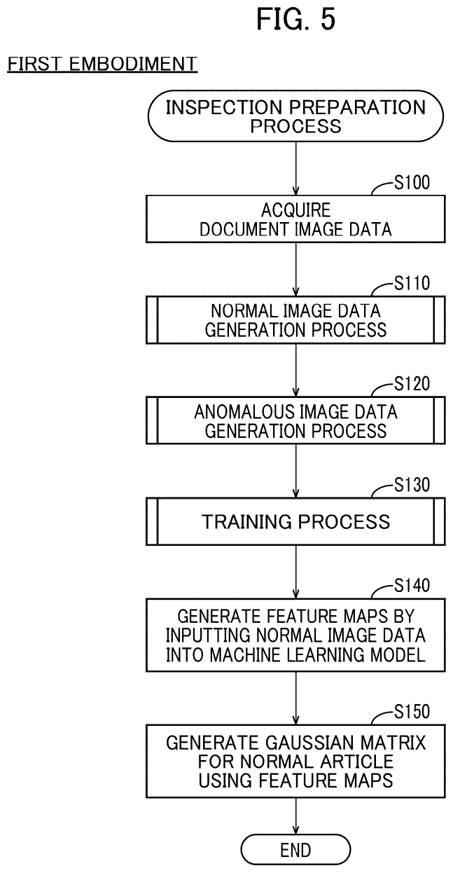

An inspection preparation process trains the machine learning model DN and generates a feature matrix (described later) for a normal article using the trained machine learning model DN. The inspection preparation process is executed prior to the inspection process described later. FIG. 5 is a flowchart illustrating steps in the inspection preparation process of the first embodiment.
In S100 of FIG. 5, the CPU 110 acquires document image data RD representing a document image DI2 from the nonvolatile storage device 130. FIG. 4B illustrates an example of the document image DI2. The document image data RD is data used to create the label L. For example, the label L is created by printing the document image DI2 on a label sheet based on the document image data RD. For the inspection process, the size (number of pixels in height and width) of the document image DI2 is adjusted (enlarged or reduced) to the same size as the image based on the input image data ID inputted into the machine learning model DN and may differ from the size used for printing the actual label L. The document image data RD is bitmap data similar to the captured image data and is RGB image data in the present embodiment. The document image DI2 is an image of a label, i.e., a label BL2, which is given the reference numeral “BL2” to distinguish this label from the actual label L. The label BL2 is a computer graphics (CG) image representing the actual label L and includes characters BX2 and marks BM2.

CG images are images generated with a computer. For example, the computer generates a CG image by rendering (also known as rasterizing) vector data containing drawing commands for drawing objects.

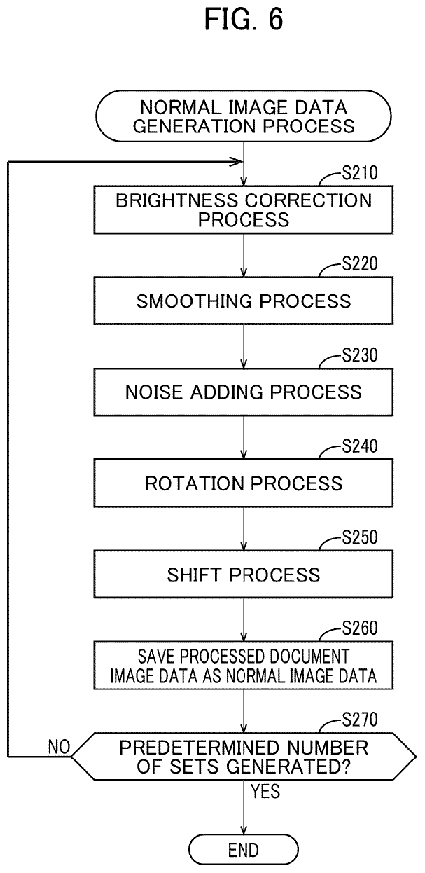

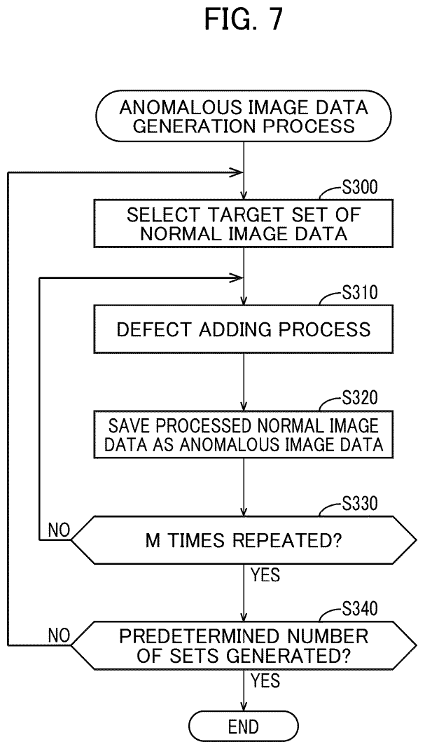

In the present embodiment, the document image DI2 includes only a label BL2 and not an image of a background. The label BL2 is not skewed in the document image DI2. In other words, the four sides of the rectangular document image DI2 are aligned with the four sides of the rectangular label BL2.
In S110 the CPU 110 executes a normal image data generation process using the document image data RD. The normal image data generation process is performed to generate normal image data representing an image of a normal article having no defects (hereinafter called a “normal image”). FIG. 6 is a flowchart illustrating steps in the normal image data generation process.
In S210 the CPU 110 executes a brightness correction process on the document image data RD. The brightness correction process modifies the brightness of the image. For example, the brightness correction process uses a gamma curve to convert each of the three component values (R value, G value, and B value) contained in an RGB value for each pixel. The γ value for the gamma curve is randomly set in the range of 0.7 to 1.3, for example. The γ value is a parameter that determines the degree of brightness correction. When the γ value is less than one, correction increases the R value, G value, and B value, resulting in higher brightness. When the γ value is greater than one, correction decreases the R value, G value, and B values, resulting in lower brightness.
In S220 the CPU 110 performs a smoothing process on the document image data RD produced from the brightness correction process. The smoothing process is performed to smooth the image by blurring edges in the image. Smoothing is performed using a Gaussian filter, for example. The standard deviation σ, which is a parameter of the Gaussian filter, is randomly set within the range of 0 to 3, for example. This provides for variation in the blurring of edges. As an alternative, smoothing may be performed using a Laplacian filter or a median filter.
In S230 the CPU 110 performs a noise adding process on the document image data RD produced from the smoothing process. The noise adding process adds noise to the image, such as normally distributed noise generated from normally distributed random numbers with mean 0 and variance 10, for example, for all pixels.
In S240 the CPU 110 executes a rotation process on the document image data RD that has undergone the noise adding process. The rotation process rotates the image by a specific rotation angle. The specific rotation angle is randomly set within the range of −3° to +3°, for example. A positive rotation angle indicates clockwise rotation, while a negative rotation angle indicates counterclockwise rotation, for example. Rotation is performed about the center of gravity of the document image DI2, for example.
In S250 the CPU 110 executes a shift process on the document image data RD produced from the rotation process. The shift process displaces the label portion of the image by a shift amount. The amount of vertical shift is randomly set within a range equivalent to a few percent of the number of pixels in the vertical direction of the document image DI2. In the present embodiment, this range is from −20 to +20 pixels. Similarly, the amount of horizontal shift is randomly set within a range equivalent to a few percent of the number of pixels in the horizontal direction, for example.
In S260 the CPU 110 saves the processed document image data RD resulting from the processes executed in S210 through S250 in the nonvolatile storage device 130 as normal image data. FIG. 4C illustrates a normal image DI3 represented by the normal image data. The normal image DI3 contains an image of a label, i.e., a label BL3. The overall brightness, orientation, position of the center of gravity, and degree of blurring of marks BM3 and characters BX3 in the label BL3 of the normal image DI3 differ from the label BL2 in the document image DI2. The size of the normal image DI3 (the number of pixels in the horizontal and vertical directions) is identical to the size of the document image DI2. Consequently, clipped regions lk are produced in the label BL3 of the normal image DI3 owing to the rotation process and shift process described above. Moreover, blank regions nt between the four edges of the normal image DI3 and the four edges of the label BL3 are created due to the rotation process and shift process described above. The blank regions nt are filled with pixels of a prescribed color, such as white.
In S270 the CPU 110 determines whether a predetermined number (e.g., several hundreds to several thousands) of sets of normal image data have been generated. When the predetermined number of sets of normal image data have not been generated (S270: NO), the CPU 110 returns to S210 to generate more data. Once the predetermined number of sets of normal image data have been generated (S270: YES), the CPU 110 ends the normal image data generation process.
In S120 of FIG. 5 following the normal image data generation process, the CPU 110 executes an anomalous image data generation process using the normal image data generated in S110. The anomalous image data generation process is performed to generate anomalous image data representing images of anomalous articles containing defects (hereinafter called “anomalous images”). FIG. 7 is a flowchart illustrating steps in the anomalous image data generation process.
In S300 of FIG. 7, the CPU 110 selects one set of normal image data from among the plurality of sets of normal image data generated in the normal image data generation process of S110 to be the process target. The target set of normal image data is selected randomly, for example.
In S310 the CPU 110 executes a defect adding process on the target set of normal image data. The defect adding process adds pseudo-defects, such as scratches, stains, or missing pieces, to the normal image DI3. In S320 the CPU 110 saves the normal image data having undergone the defect adding process in the nonvolatile storage device 130 as anomalous image data.

An anomalous image DI4 represented by the anomalous image data contains an image of a label, i.e., a label BL4. The label BL4 contains pseudo-defects. For example, the anomalous image DI4 in FIG. 4D includes an image depicting a pseudo-scratch in the form of a line (hereinafter called a “pseudo-scratch df4”) as a pseudo-defect. The pseudo-scratch df4 is a curved line depicted using a Bézier curve or a spline curve, for example. The CPU 110 generates the pseudo-scratch df4 by randomly setting the number and positions of control points, the thickness of the line, and the color of the line for a Bézier curve within predetermined ranges, for example. The CPU 110 then overlays the generated pseudo-scratch df4 onto the normal image DI3 to generate anomalous image data representing the anomalous image DI4. Anomalous image data including a defect other than a scratch, such as a pseudo-stain, may also be generated. A pseudo-stain may be generated by arranging numerous minute dots in a predetermined area, for example. A pseudo-defect may also be generated by capturing an image of an actual defect and extracting the area of the defect from the image.
In S330 the CPU 110 determines whether the process in S310 and S320 has been repeated M times (where M is an integer greater than or equal to two). In other words, the CPU 110 determines whether M different sets of anomalous image data have been generated based on the current target set of normal image data. When the process in S310 and S320 has not been repeated M times (S330: NO), the CPU 110 returns to S310 to repeat the process. Once the process in S310 and S320 has been repeated M times (S330: YES), the CPU 110 advances to S340. M is an integer in the range of two to five, for example.
In S340 the CPU 110 determines whether a predetermined number (e.g., several hundreds to several thousands) of sets of anomalous image data have been generated. While the predetermined number of sets of anomalous image data have not been generated (S340: NO), the CPU 110 returns to S300 and repeats the above process. When the predetermined number of sets of anomalous image data have been generated (S340: YES), the CPU 110 ends the anomalous image data generation process.
In S130 following the anomalous image data generation process, the CPU 110 executes a training process. The training process is performed to adjust calculation parameters in the machine learning model DN using the normal image data and anomalous image data as the input image data ID.

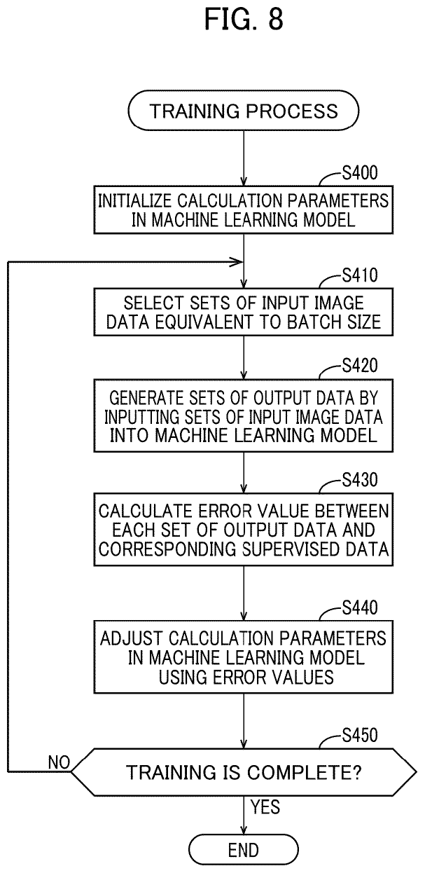

FIG. 8 is a flowchart illustrating steps in the training process. In S400 of FIG. 8, the CPU 110 initializes a plurality of calculation parameters in the machine learning model DN. For example, the initial values of these calculation parameters are set to random numbers individually obtained from the same distribution (e.g., a normal distribution).
In S410 the CPU 110 selects a number of sets of input image data ID equivalent to a batch size from among the plurality of sets of input image data (normal image data and anomalous image data in the present embodiment). For example, the plurality of sets of input image data ID is divided into a plurality of groups (batches), each containing V sets of input image data ID (where V is an integer greater than or equal to two, such as one hundred). The CPU 110 then selects V sets of input image data ID to be used by selecting one group at a time from these groups. Alternatively, V sets of input image data may be randomly selected from the plurality of sets of input image data ID each time the process of S410 is performed.
In S420 the CPU 110 inputs the selected V sets of input image data ID into the machine learning model DN to generate V sets of output data OD having a one-on-one correspondence with the V sets of input image data ID. The output data OD corresponding to a set of input image data ID signifies output data OD generated by the machine learning model DN when the set of input image data ID is inputted into the machine learning model DN.
In S430 the CPU 110 calculates an error value EV between the output data OD and supervised data corresponding to that output data OD for each of the V sets of output data OD. Supervised data corresponding to output data OD is data specifying the desired target value of the output data OD. For example, the supervised data corresponding to the output data OD specifies a normal image (i.e., that the label in the image is a normal article) when the input image data ID corresponding to the output data OD is normal image data. The supervised data corresponding to the output data OD specifies an anomalous image (i.e., that the label in the image is an anomalous article) when the input image data ID corresponding to the output data OD is anomalous image data.

The error value EV is calculated according to a prescribed loss function. For example, the mean squared error (MSE) may be used to calculate the error value EV.
In S440 the CPU 110 uses the V error values EV to adjust the plurality of calculation parameters in the machine learning model DN. Specifically, the CPU 110 adjust the calculation parameters according to a prescribed algorithm in order to reduce the error values EV, i.e., to reduce the differences between the output data OD and the supervised data. An algorithm using error backpropagation and gradient descent (e.g., Adam) may be used as the prescribed algorithm.
In S450 the CPU 110 determines whether training is complete. In the present embodiment, the CPU 110 determines that training is complete when the operator has inputted a termination instruction and determines that training is not complete when the operator has inputted a continuation instruction. In the present embodiment, it is not possible nor necessary to continue training until the machine learning model DN can perfectly discriminate between abnormal and normal images. Training is terminated once the machine learning model DN has sufficiently learned the features of the label L. For example, the operator monitors changes in the error values EV during the training process, inputting a continuation instruction when the error values EV are in a downward trend and inputting a termination instruction when determining that the error values EV have stopped their downward trend and remain flat or have shifted to an upward trend. As a variation, the CPU 110 may determine that training is complete after the process in S410 through S440 has been repeated a predetermined number of times.

While the CPU 110 determines that training is not complete (S450: NO), the CPU 110 returns to S410. Once the CPU 110 determines that training is complete (S450: YES), the CPU 110 ends the training process. Training of the machine learning model DN is complete once the training process ends. At the end of training, the machine learning model DN is a trained model with properly adjusted calculation parameters.

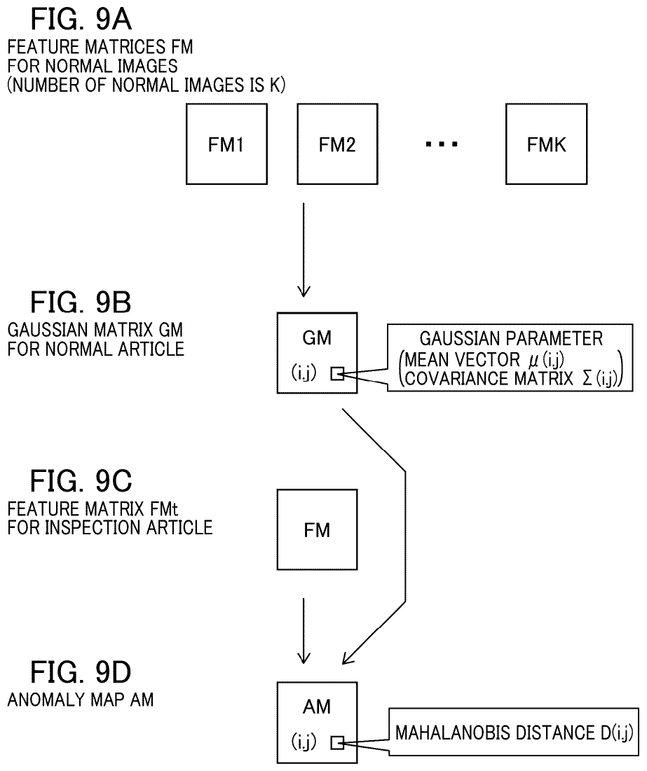

Following the training process in S130 of FIG. 5, in S140 and S150 the CPU 110 extracts features of a normal article using K sets of normal image data IDn. Here, K is an integer greater than or equal to one, such as a value in the range of 10 to 100. FIG. 3B conceptually illustrates feature extraction for a normal article. The K sets of normal image data IDn for extracting features are randomly selected from the sets of normal image data used in the training process.
In S140 the CPU 110 inputs each of the K sets of normal image data IDn into the trained machine learning model DN (the encoder EC) as the input image data ID to generate a plurality of feature maps fm (see FIG. 3B). In the present embodiment, three types of feature maps fm1, fm2, and fm3 are generated by inputting one set of normal image data IDn into the machine learning model DN. As illustrated in FIG. 3A, the feature maps fm1 are generated by the first convolutional layer conv1. The feature maps fm2 are generated by the second convolutional layer conv2. The feature maps fm3 are generated by the third convolutional layer conv3. Each feature map fm is image data of a predetermined size. When the total number of feature maps fm1, fm2, and fm3 generated from one set of input image data ID is P, then (P×K) feature maps fm are generated using the K sets of normal image data IDn in the present embodiment. Here, P is between several hundred and several thousand, for example.
In S150 the CPU 110 generates a Gaussian matrix GM for a normal article using the (P×K) feature maps fm. The process of generating the Gaussian matrix GM will be described with reference to FIGS. 3B, 3C, 3D, and 9. For example, the CPU 110 randomly selects L (e.g., from several ten to several hundred) effective maps Um (see FIG. 3C) from the P feature maps fm (see FIG. 3B) generated from one set of input image data ID. When the L effective maps fm differ in size (number of pixels), the sizes of the L effective maps Um are made equal through enlargement or reduction processes. The CPU 110 generates a feature matrix FM for the normal image (see FIG. 3D) using the L effective maps Um. That is, the CPU 110 generates a feature matrix FM for a normal image represented by one set of normal image data using the effective maps Um (see FIG. 3C) selected from among the P feature maps fm (see FIG. 3B), which have been generated from the same set of normal image data. The elements of the feature matrix FM are feature vectors V(i, j) that have a one-on-one correspondence with each pixel in the effective maps Um, where (i, j) denotes the coordinates of the corresponding pixel in the effective maps Um. The elements of a feature vector are the values of pixels at coordinates (i, j) in the L effective maps Um. Thus, a single feature vector is an L-dimensional vector (a vector with L elements; see FIG. 3D).

The feature matrix FM for a normal image is generated for each normal image (each set of normal image data). Since the number of sets of normal image data is K in the present embodiment, the CPU 110 generates K feature matrices FM1-FMK. FIGS. 9A through 9D are explanatory diagrams illustrating the matrices and maps used in the present embodiment. FIG. 9A illustrates an example of the K feature matrices FM1-FMK for normal images. The CPU 110 uses these K feature matrices FM1-FMK for normal images to generate a Gaussian matrix GM indicating features of the normal article. The elements of the Gaussian matrix GM are Gaussian parameters having a one-on-one correspondence to pixels in the effective maps Um. The Gaussian parameters corresponding to pixels at coordinates (i, j) include the mean vector (i, j) and the covariance matrix Σ(i, j). The mean vector μ(i, j) is the average of the feature vectors V(i, j) of the K feature matrices FM1-FMK for normal images. The covariance matrix Σ(i, j) is a covariance matrix of feature vectors V(i, j) of the K feature matrices FM1-FMK for normal images. Thus, a single Gaussian matrix GM is generated for K sets of normal image data.

After calculating the Gaussian matrix GM depicting features of the normal article, the CPU 110 ends the inspection preparation process. The trained machine learning model DN and the Gaussian matrix GM generated in this inspection preparation process are used in the inspection process. For this purpose, the machine learning model DN and Gaussian matrix GM are saved in the nonvolatile storage device 130.

### A-3. Inspection Process

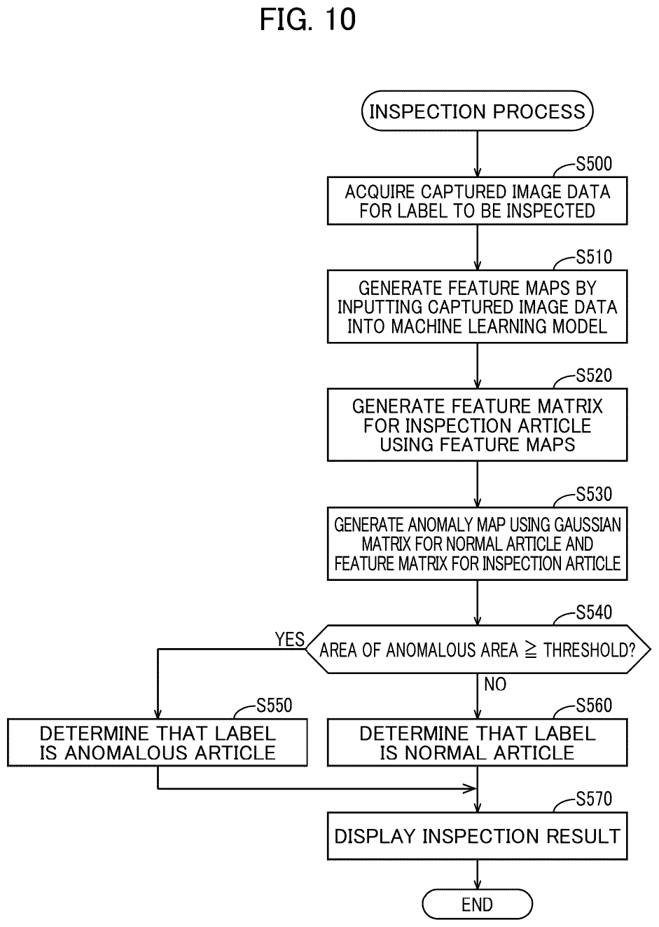

FIG. 10 is a flowchart illustrating steps in the inspection process. The inspection process is performed to inspect whether the label L under inspection is an anomalous article containing defects or a normal article containing no defects. The inspection process is executed for each label L. The inspection device 100 begins the inspection process when a user (e.g., an inspection operator) inputs an instruction to start the process into the inspection device 100 via the operation unit 150. For example, the user inputs an instruction to start the inspection process while the product 300 having the label L to be inspected affixed thereto is in a prescribed position allowing its image to be captured by the imaging device 400.
In S500 of FIG. 10, the CPU 110 acquires captured image data IDt representing a captured image including an image of the label L to be inspected (hereinafter also called the “inspection article”). For example, the CPU 110 transmits a photographing instruction to the imaging device 400 instructing the imaging device 400 to generate captured image data and acquires this captured image data from the imaging device 400. As a result, the CPU 110 acquires captured image data representing the captured image DI1 in FIG. 4A described above, for example.
In S510 and S520 the CPU 110 uses the captured image data IDt to extract features of the inspection article therefrom.
In S510 the CPU 110 generates P feature maps fm corresponding to the captured image data IDt by inputting the captured image data IDt acquired in S500 into the trained machine learning model DN as the input image data ID. In the present embodiment, the CPU 110 generates P feature maps fm1-fm3, as illustrated in FIG. 3B.
In S520 the CPU 110 uses the P feature maps fm1-fm3 to generate a feature matrix FMt for the inspection article. The feature matrix FMt for the inspection article is generated according to the same process described above for generating the feature matrix FM for a normal image (see FIG. 3D). That is, the CPU 110 uses L effective maps Um selected from among the P feature maps fm1-fm3 generated in S510 to produce the feature matrix FMt for the inspection article. The elements of the feature matrix FMt are feature vectors V(i, j) having a one-on-one correspondence to the pixels in the effective maps Um.
In S530 the CPU 110 generates an anomaly map AM (see FIG. 9D) using the Gaussian matrix GM that indicates features of the normal article and the feature matrix FMt for the inspection article. The anomaly map AM is image data having the same size (same number of pixels) as the feature matrix FMt. The value of each pixel in the anomaly map AM is a Mahalanobis distance. The Mahalanobis distance D(i, j) at coordinates (i, j) is calculated using the feature vectors V(i, j) of the feature matrix FM for the inspection article, and the mean vector μ(i, j) and covariance matrix Σ(i, j) of the Gaussian matrix GM for a normal article. The Mahalanobis distance D(i, j) is a value indicating the degree of difference between the K normal images and the inspection article at coordinates (i, j). Thus, the Mahalanobis distance D(i, j) can be considered a value representing an anomaly score for the inspection article at coordinates (i, j).

FIG. 4E illustrates a sample anomaly map AMa. The anomaly map AMa in FIG. 4E depicts an anomalous area df5. The anomalous area df5 is composed of pixels for which the Mahalanobis distance is greater than or equal to a threshold TH, for example. The anomalous area df5 depicts the area in which the scratch df1 contained in the captured image DI1 of FIG. 4A is located. By referencing the anomaly map AMa, the CPU 110 can identify the position, size, and shape of a scratch or other defect contained in the captured image DI1. When the captured image DI1 does not contain a scratch or other defect, no anomalous area will be identified in the anomaly map AMa.
In S540 the CPU 110 determines whether the area of the anomalous area df5 in the anomaly map AMa is greater than or equal to a threshold THj. When the area of the anomalous area df5 is smaller than the threshold THj (S540: NO), in S560 the CPU 110 determines that the label L under inspection is a normal article. However, when the area of the anomalous area df5 is greater than or equal to the threshold THj (S540: YES), in S550 the CPU 110 determines that the label L under inspection is an anomalous article. In S570 the CPU 110 displays the inspection result on the display unit 140 and subsequently ends the inspection process. In this way, the CPU 110 can use the machine learning model DN to accurately determine whether a label L under inspection is a normal article or an anomalous article.

The methods of generating feature matrices FM and FMt, Gaussian matrices GM, and anomaly maps AM are described in detail in a paper on a PaDiM model by T. Defard, A. Setkov, A. Loesch, and R. Audigier entitled, “PaDiM: a Patch Distribution Modeling Framework for Anomaly Detection and Localization” (arXiv: 2011.08785(2020), https://arxiv.org/abs/2011.08785).

As described above, the machine learning model DN in the present embodiment includes an encoder EC (see FIG. 3A) for generating feature data of a label L under inspection (feature maps fm1-fm3 in the present embodiment) when captured image data of the label L is inputted into the machine learning model DN. The encoder EC is trained (FIGS. 5 and 8) using training image data (normal image data and anomalous image data in the present embodiment). The training image data is image data obtained by performing specific image processes on the document image data RD used to create the actual label L (FIGS. 6 and 7).

As a result, a machine learning model DN is provided that can create enough captured image data required during training the machine learning model DN even when sufficient captured image data is not available to be inputted into the machine learning model DN. Hence, the number of sets of captured image data required for anomaly detection using a machine learning model can be reduced. If the captured image data to be used as training image data is obtained by capturing images of actual labels L with the imaging device 400, including both normal and anomalous articles, a large number of such actual labels L must be prepared. For anomalous articles in particular, a variety of defects including scratches and stains must be added to the labels L before capturing images of the labels L. Consequently, the user's burden for training the machine learning model DN may increase excessively. However, since the document image data RD is used to generate training image data in the above embodiment, the burden on the user for training the machine learning model DN is reduced, facilitating the user in training the machine learning model DN.

Specific image processes used for generating normal image data in the above embodiment include the brightness correction process, smoothing process, noise adding process, rotation process, and shift process (S210 through S250 of FIG. 6). Specific image processes used in the embodiment for generating anomalous image data include, in addition to the above processes, defect adding process (S310 of FIG. 7). Imaging conditions and other factors can lead to variations in attributes of captured images, and specifically variations in brightness, degree of blurring, degree of noise, skew, and position. According to the above embodiment, the encoder EC can be trained to generate suitable feature maps fm and hence a suitable feature matrix FMt, even when captured image data containing such variations is inputted into the encoder EC.

In the above embodiment, the training image data includes normal image data representing an image of a normal object (a label in this embodiment) and anomalous image data representing an image of an object containing defects (FIGS. 5-7). The encoder EC is trained by configuring an image recognition model (the machine learning model DN in FIG. 2) to generate output data OD indicating image recognition results based on data outputted from the encoder EC. That is, training is performed so that when training image data (normal image data or anomalous image data) is inputted into the encoder EC, the output data OD identifies whether the label represented by the training image data is a normal article or an anomalous article. In other words, the training is executed so that the output data OD indicates whether the training image data is normal image data or anomalous image data. As a result, this embodiment provides an encoder EC suitably trained using training image data that includes both normal image data and anomalous image data.

According to the above embodiment, the specific image processes executed on the document image data RD include a first image process (e.g., the brightness correction process, smoothing process, noise adding process, rotation process, and shift process described in S210 through S250 of FIG. 6) for adjusting image attributes (e.g., brightness, degree of blurring, degree of noise, skew, and position). These image attributes can vary due to variations in factors other than defects, which should be identified as anomalies. The specific image processes also include a second image process (defect adding process in S310 of FIG. 7) for adding pseudo-defects to the image. By executing the second image process M times (where M is an integer greater than or equal to two) on one set of normal image data generated through one first image process, the inspection device 100 generates M sets of anomalous image data (S300 through S330 of FIG. 7). By generating M sets of anomalous image data using one set of normal image data, this process can efficiently generate anomalous image data.

By executing the second image process M times on each of n sets of normal image data (where n is an integer greater than or equal to two) in the above embodiment, the CPU 110 generates (n×M) sets of anomalous image data (S330 and S340 of FIG. 7). As a result, the CPU 110 can efficiently generate a large number (e.g., several thousand) of sets of anomalous image data.

In the above embodiment, the CPU 110 generates feature maps fm for a normal label L by inputting normal image data for feature extraction into the trained machine learning model DN (S140 of FIG. 5; FIG. 3B) and uses the feature maps fm for a label L under inspection and the feature maps fm for the normal label L to detect anomalies in the label L (S510 through S560 of FIG. 10). The normal image data for feature extraction is obtained by performing adjustment of image attributes on the document image data RD through various processes (e.g., brightness correction, smoothing, noise addition, rotation, and shifting as described in S210 through S250 of FIG. 6). With this configuration, the CPU 110 can generate feature maps for a normal label L, even when sufficient captured image data is not available. Therefore, this configuration can reduce the number of sets of captured image data required for detecting anomalies with the machine learning model DN. When captured image data obtained by capturing an image of an actual label L that is a normal article with the imaging device 400 is used as the normal image data for feature extraction, a large number of actual labels L must be prepared. This may place excessive burden on the user for performing anomaly detection with the machine learning model DN. However, since the inspection device 100 in the above embodiment uses document image data RD to generate normal image data for feature extraction, the inspection device 100 can reduce the burden on the user for detecting anomalies with the machine learning model DN.

As can be understood from the above description, in the present embodiment, the brightness correction process, smoothing process, noise adding process, rotation process, and shift process are all examples of the first image process of the present disclosure, and the defect adding process is an example of the second image process of the present disclosure. The normal image data of the present embodiment is an example of the training image data, first image data, and image data for feature extraction of the present disclosure, and the anomalous image data of the present embodiment is an example of the training image data and second image data of the present disclosure. The document image data RD of the present embodiment is an example of the original image data of the present disclosure.

### B. Second Embodiment

In the first embodiment, the encoder EC is trained by configuring a machine learning model DN, which is an image recognition model including the encoder EC, and by training the machine learning model DN. However, the method of training the encoder is not limited to this method.

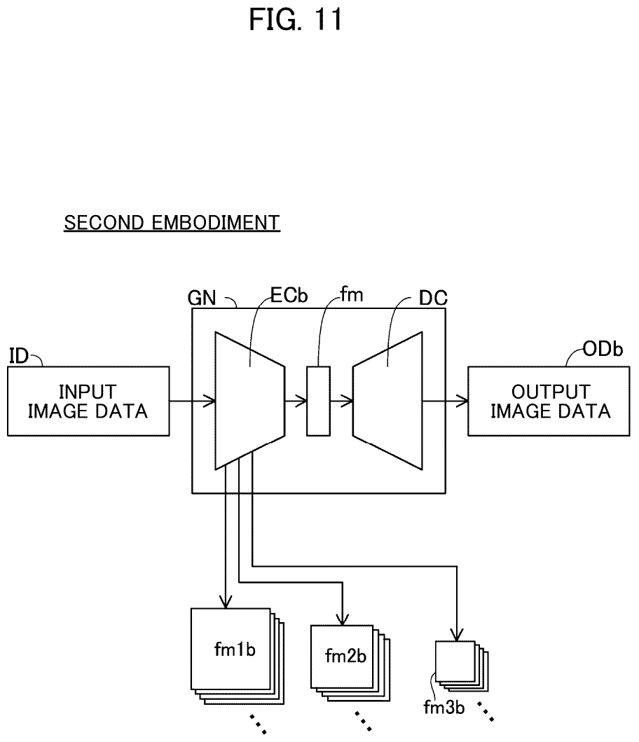

FIG. 11 is a schematic diagram illustrating the configuration of a machine learning model GN according to a second embodiment. The machine learning model GN of the second embodiment is an image generation model that includes an encoder ECb. Specifically, the machine learning model GN is a neural network called an autoencoder that includes the encoder ECb, and a decoder DC.

As in the first embodiment, the encoder ECb is a CNN that includes a plurality of convolutional layers, for example. The feature maps fm outputted from the encoder ECb, i.e., the feature maps fm produced by the last convolutional layer are inputted into the decoder DC. The decoder DC performs dimensional restoration on the feature maps fm to generate output image data ODb (see FIG. 11). The decoder DC includes a plurality of up-convolutional layers not illustrated in the drawing. Each up-convolutional layer performs up-convolution using a filter having a prescribed size. The calculated values of each up-convolution are values transformed by inputting the input image data ID to which biases are added into a prescribed activation function. A well-known function such as ReLU described above is used as the activation function in the present embodiment. The output image data ODb is RGB image data having the same size as the input image data ID, for example.

The filter weights and biases used in convolutions in the encoder ECb and the weights and biases used in up-convolutions in the decoder DC are calculation parameters that are adjusted through the training process according to the present embodiment.

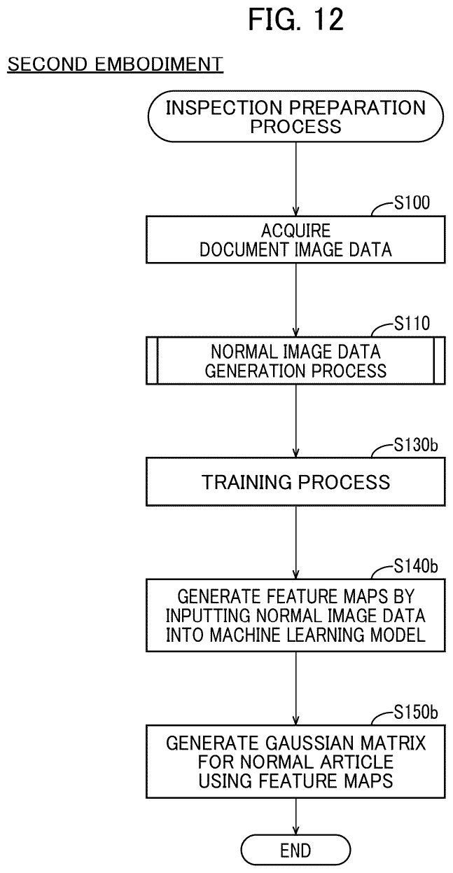

FIG. 12 is a flowchart illustrating steps in an inspection preparation process according to the second embodiment. S100 and S110 of FIG. 12 are identical processes to S100 and S110 of FIG. 5. In the inspection preparation process of the second embodiment, the CPU 110 does not execute the anomalous image data generation process described in S120 of FIG. 5 and does not generate anomalous image data. Thus, unlike step S130 of FIG. 5 in the first embodiment, in S130b of FIG. 12 the CPU 110 trains the machine learning model GN using only normal image data. Specifically, the machine learning model GN is trained so that when normal image data is inputted into the encoder ECb, output image data ODb generated by the decoder DC reproduces the inputted normal image data.

For example, V sets of normal image data equivalent to the batch size are inputted into the machine learning model GN to generate V sets of output image data ODb corresponding to the V sets of normal image data. The CPU 110 calculates the error value between normal image data and corresponding output image data ODb using a predetermined loss function for each pair of sets of normal image data and output image data ODb. For example, the mean squared error for all pixels is used as the predetermined loss function. The CPU 110 then adjusts the calculation parameters according to a prescribed algorithm in order to reduce the V error values, i.e., to reduce the differences between the normal image data and the output image data ODb. The above process is repeated a plurality of times to train the machine learning model GN.
In S140b of FIG. 12, as in S140 of FIG. 5, the CPU 110 inputs each of the K sets of normal image data randomly selected from the sets of normal image data used in the training process into the trained machine learning model GN (the encoder ECb) as the input image data ID to generate a plurality of feature maps fm1b-fm3b (see FIG. 11). The feature maps fm1b-fm3b are each generated by three convolutional layers selected from among the plurality of convolutional layers comprising the encoder ECb.
In S150b of FIG. 12, as in S150 of FIG. 5, the CPU 110 generates a Gaussian matrix for a normal article using the plurality of feature maps generated in S140b.

The inspection process in the second embodiment is executed similarly to the inspection process in the first embodiment (see FIG. 10).

In the second embodiment described above, training of the encoder ECb is performed by configuring the machine learning model GN, which is an image generation model including the encoder ECb and a decoder DC for generating output image data ODb using data outputted from the encoder ECb (see FIG. 11). Training of the encoder ECb is also performed so that when normal image data is inputted into the encoder ECb, the decoder DC generates output image data ODb designed to reproduce the normal image data (see FIG. 12). With this configuration, the encoder ECb can be trained using only normal image data and not anomalous image data. As a result, the user's burden of preparing training image data can be further reduced from that in the first embodiment.

### C. Modifications of the Embodiments

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:
(1) In the first embodiment described above, the same normal image data is used to train the encoder EC and to generate the Gaussian matrix GM for a normal article. However, the adjustment ranges used in processes for adjusting image attributes (and specifically the brightness correction process, smoothing process, noise adding process, rotation process, and shift process) may be varied between the normal image data used for training the encoder EC and the normal image data used for generating the Gaussian matrix GM for a normal article. If the adjustment processes performed when generating the normal image data to be used for generating the Gaussian matrix GM are collectively called the first adjustment process and the adjustment processes performed when generating the normal image data to be used in the training process are collectively called the second adjustment process, in this modification the maximum adjustment amounts of the attributes in the second adjustment process is greater than the maximum adjustment amounts of the attributes in the first adjustment process. As an example, the γ value for the gamma curve is randomly set within the range of 0.7 to 1.3 for the brightness correction process in the first adjustment process and is randomly set within the range of 0.4 to 1.6 for the brightness correction process in the second adjustment process. As another example, the standard deviation σ for the Gaussian filter is randomly set within the range of 0 to 1.5 for the smoothing process in the first adjustment process and is randomly set within the range of 0 to 3 for the smoothing process in the second adjustment process. As still another example, the percentage of noise is randomly set within the range of 0 to 6% for the noise adding process in the first adjustment process and is randomly set within the range of 0 to 12% for the noise adding process in the second adjustment process. The same applies to the rotation process and shift process.

According to this modification, the encoder EC is trained to properly generate feature maps fm and hence the Gaussian matrix GM, even when the input image data ID inputted into the encoder EC has large variations in attributes. This makes the encoder EC more versatile. Thus, even if the encoder EC has been trained using normal image data for a single set of label L, for example, normal image data for a plurality of sets of labels L can be used to generate a suitable Gaussian matrix GM of a normal article for each label L.

For example, even if the overall composition of a label such as its base color and text color is the same, the part numbers and other information on the label may vary depending on the shipping destination. In such cases, the encoder EC is trained with normal image data generated using document image data RD for one destination (e.g., Japan). Then, a Gaussian matrix GM for normal articles can be generated with that encoder EC using normal image data generated from document image data RD of labels for other destinations (e.g., the United States). In other words, one encoder EC can be used to inspect labels L for a plurality of destinations.
(2) The above embodiments consider the brightness, degree of blurring, amount of noise, skew, and position of labels as specific attributes that vary due to variations in captured images DI1. However, other attributes may also be considered. For example, since the captured image DI1 is generated with the imaging device 400, the captured image DI1 may include size variations or distortions not found in the actual label or the document image. Accordingly, the machine learning model DN may be trained so that a feature matrix FMt suitable for inspection articles can be generated even when variations of size or distortion are produced in the captured image DI1 of an inspection article. In this case, when generating normal image data, for example, processes for modifying the size of the image and adding distortion may be provided together with or instead of at least some of the brightness correction process, smoothing process, noise adding process, rotation process, and shift process. The process for modifying the image size may be a process for reducing or enlarging the image by a predetermined scale. The process for adding distortion may include a process for adding simulated trapezoidal distortion or lens distortion, for example.
(3) In the above embodiments, anomalous image data is generated by performing the defect adding process on the normal image data (see FIG. 7). However, anomalous image data may instead be generated by performing the brightness correction process, smoothing process, noise adding process, rotation process, and shift process after performing the defect adding process on the document image data RD. Although the creation of anomalous image data in this case is less efficient than in the embodiments, this method can produce anomalous image data depicting images with a more natural captured image appearance. The brightness correction process, smoothing process, noise adding process, rotation process, and shift process are all processes designed to add an effect of variation caused by different imaging conditions. Since such variations due to imaging conditions also affect defects during actual imaging, it may be desirable to add such effects to the images of pseudo-defects, as well.
(4) In the above embodiments, M sets of anomalous image data (where M is an integer greater than or equal to two) are generated from a single set of normal image data. However, a single set of anomalous image data may be generated from each set of normal image data instead.
(5) In the above embodiments, both training image data (normal image data and anomalous image data) for training the machine learning models DN and GN and normal image data for generating the Gaussian matrix GM for a normal article are generated using document image data RD. However, one of the training image data for training the machine learning models DN and GN and the normal image data for generating the Gaussian matrix GM for a normal article may be generated by capturing an image of the actual label L, for example.
(6) While the inspection object is a label in the above embodiments, the inspection object may be other objects as well, such as any of various industrially manufactured products (e.g., final products that are ultimately sold on the market or parts used in the manufacture of final products). In this case, the normal image data is generated by performing the normal image data generation process of FIG. 6 on design image data used to create the product rather than document image data RD.
(7) The normal image data generation process in the above embodiments (see FIG. 6) is just one example and steps in the process may be modified or omitted as appropriate. For example, processes that adjust attributes considered to be less important depending on the form of the inspection process, for example, may be omitted from among the brightness correction process, smoothing process, noise adding process, rotation process, and shift process in the embodiments. The brightness correction process may be omitted, for example, when stable brightness can be ensured in the environment where an image of the label is being captured.

Further, not all training image data (normal image data and anomalous image data) must be generated using document image data RD. The training process may be performed using both training image data generated using the document image data RD and training image data generated by capturing images. Additionally, all normal image data used to produce the Gaussian matrix GM for a normal article need not be generated from the document image data RD. The Gaussian matrix GM for a normal article may be generated using both normal image data generated using document image data RD and normal image data generated by capturing images.
(8) In the above embodiments, all training image data (normal image data and anomalous image data) is generated using the document image data RD. As an alternative, all training image data may be generated using image data different from image data used to create labels L, such as the document image data RD. For example, all training image data may be captured image data acquired by a digital camera or the like imaging actual labels L. In this case, a plurality of sets of captured image data obtained while varying imaging conditions such as the type and brightness of the light source and the position of the digital camera relative to the label L within ranges considered appropriate by the user may be used as the plurality of sets of training image data.

Alternatively, all training image data may be generated using captured image data acquired by a digital camera or the like imaging actual labels L as original image data. For example, a plurality of different sets of training image data (normal image data and anomalous image data) may be generated by performing a plurality of different image processes on one set of captured image data serving as the original image data, including such processes as the brightness correction process, smoothing process, noise adding process, rotation process, and shift process. In S100 of the inspection preparation process according to the first embodiment described in FIG. 5, for example, the CPU 110 may acquire one set of captured image data and may use this captured image data in place of the document image data RD when executing the normal image data generation process of S110 to generate normal image data. The CPU 110 further uses the normal image data generated from this captured image data when executing the anomalous image data generation process of S120 to generate anomalous image data. The CPU 110 then performs the processes in S130 through S150 using the anomalous image data and normal image data generated from the captured image data. As a result, multiple sets of normal image data and anomalous image data can be generated using a single set of captured image data, for example, enabling the machine learning model to be trained and feature data to be generated for a normal object, even when sufficient captured image data is unavailable. Therefore, the number of sets of captured image data required for anomaly detection with a machine learning model can be reduced.
(9) The machine learning models DN and GN in the above embodiments are just one example, and the present disclosure is not limited to this example. Any image recognition model having at least an encoder that includes a CNN, such as a VGG16 or VGG19, may be used as the machine learning model DN in the first embodiment. Any image generation model having an encoder that includes a CNN, and a decoder may be used as the machine learning model GN in the second embodiment. The machine learning model GN is also not limited to an ordinary autoencoder but may be configured of a vector quantized variational autoencoder (VQ-VAE) or variational autoencoder (VAE) or an image generation model included in generative adversarial networks (GANs). Regardless of what machine learning model is being used, the composition and number of specific layers in the model, such as the convolutional layers and up-convolutional layers, may be modified as needed. Additionally, post-processes performed on values outputted by each layer of the machine learning model may also be modified as needed. For example, the activation function used in post-processing may be any of various functions including ReLU, Leaky ReLU, PReLU, softmax, and sigmoid.
(10) In the above embodiments, the inspection device 100 illustrated in FIG. 1 executes the inspection preparation process and the inspection process, but these processes may be executed by separate devices instead. In this case, the trained encoders EC and ECb and the Gaussian matrix GM for normal articles generated in the inspection preparation process are stored in a storage device of the device executing the inspection process, for example. All or part of the inspection preparation process and the inspection process may be executed by a plurality of computers (e.g., cloud servers) capable of communicating with each other over a network. Further, the computer program that implements the inspection process may be different from the computer program that implements the inspection preparation process.

Part of the configuration implemented in hardware in the embodiment described above may be replaced with software and, conversely, all or part of the configuration implemented in software may be replaced with hardware. For example, all or part of the inspection preparation process and inspection process may be implemented with a hardware circuit, such as an application specific integrated circuit (ASIC).

What is claimed is:

1. A method of producing a non-transitory computer-readable storage medium storing a machine learning model, the machine learning model being used for anomaly detection to detect an anomaly in an object, the machine learning model including an encoder configured to generate feature data for the object in response to captured image data obtained by capturing an image of the object being inputted, the encoder including a convolutional neural network, the method comprising:
training the encoder using training image data, the training image data being obtained by performing a specific image process on original image data, the original image data representing the image of the object and being used to create the object.

2. The method according to claim 1,
wherein the object includes a normal object and an anomalous object, the anomalous object containing the anomaly,
wherein the training image data is normal image data representing an image of the normal object,
wherein the training configures an image generation model including the encoder and a decoder, the decoder being configured to generate output image data using data outputted from the encoder, and
wherein the training is performed such that when the training image data is inputted into the encoder, the output image data generated by the decoder reproduces the training image data.

3. The method according to claim 1,
wherein the object includes a normal object and an anomalous object, the anomalous object containing the anomaly,
wherein the training image data includes first image data representing an image of the normal object and second image data representing an image of the anomalous object,
wherein the training configures an image recognition model configured to generate output data indicating a recognition result of an image using data outputted from the encoder, and
wherein the training is performed such that when the training image data is inputted into the encoder, the output data identifies whether the training image data is the first image data or the second image data.

4. The method according to claim 3,
wherein the specific image process includes a first image process and a second image process, the first image process adjusting an image attribute that is variable due to variations in factors other than a defect that should be identified as the anomaly, the second image process adding a pseudo-defect that should be identified as the anomaly to an image, and
wherein by executing the second image process M times on one set of the first image data generated through a single execution of the first image process, M sets of the second image data are generated, where M is an integer greater than or equal to two.

5. The method according to claim 3,
wherein the specific image process includes a first image process and a second image process, the first image process adjusting an image attribute that is variable due to variations in factors other than a defect that should be identified as the anomaly, the second image process adding a pseudo-defect that should be identified as the anomaly to an image, and
wherein by executing the second image process m times on each of n sets of the first image data, (n×m) sets of the second image data are generated, where m is an integer greater than or equal to one, and n is an integer greater than or equal to two.

6. The method according to claim 1,
wherein the object includes a normal object and an anomalous object, the anomalous object containing the anomaly,
wherein the anomaly detection includes:
generating image data for feature extraction by executing a first adjustment process on the original image data, the image data for feature extraction representing an image of the normal object;
generating feature data for the normal object by inputting the image data for feature extraction into the machine learning model trained in the training; and
detecting an anomaly in an inspection object using the feature data for the normal object and feature data for the inspection object.

7. The method according to claim 6,
wherein the first adjustment process adjusts an image attribute that is variable due to variations in factors other than a defect that should be identified as the anomaly,
wherein the specific image process includes a second adjustment process adjusting the image attribute, and
wherein a maximum adjustment amount of the image attribute in the second adjustment process is greater than a maximum adjustment amount of the image attribute in the first adjustment process.

8. The method according to claim 1,
wherein the object is a label affixed to a product.

9. A non-transitory computer-readable storage medium storing a set of computer-readable instructions for performing anomaly detection with a machine learning model, the anomaly detection detecting an anomaly in an object including a normal object and an anomalous object containing the anomaly, the machine learning model including an encoder configured to generate feature data for the object in response to captured image data obtained by capturing an image of the object being inputted, the encoder including a convolutional neural network, the set of computer-readable instructions, when executed by a computer, causing the computer to perform:
generating image data for feature extraction by executing a first adjustment process on original image data, the original image data representing an image of the object and being used to create the object, the image data for feature extraction representing an image of the normal object; and
generating feature data for the normal object by inputting the image data for feature extraction into the machine learning model that has been trained; and
detecting an anomaly in an inspection object using the feature data for the normal object and feature data for the inspection object.

10. The non-transitory computer-readable storage medium according to claim 9,
wherein the encoder is trained using training image data, the training image data being obtained by executing a specific image process on the original image data.

11. The non-transitory computer-readable storage medium according to claim 10,
wherein the first adjustment process adjusts an image attribute that is variable due to variations in factors other than a defect that should be identified as the anomaly,
wherein the specific image process includes a second adjustment process adjusting the image attribute, and
wherein a maximum adjustment amount of the image attribute in the second adjustment process is greater than a maximum adjustment amount of the image attribute in the first adjustment process.

12. The non-transitory computer-readable storage medium according to claim 9,
wherein the object is a label affixed to a product.

13. A method of detecting an anomaly in an object with a machine learning model, the object including a normal object and an anomalous object containing the anomaly, the machine learning model including an encoder configured to generate feature data for the object in response to captured image data obtained by capturing an image of the object being inputted, the encoder including a convolutional neural network, the method comprising:
training the encoder using training image data;
generating feature data for the normal object by inputting image data for feature extraction into the encoder trained in the training; and
detecting an anomaly in an inspection object using the feature data for the normal object and feature data for the inspection object,
wherein at least one of the training image data and the image data for feature extraction is obtained by executing a specific process on original image data, the original image data representing an image of the object and being used to create the object.

14. A method of producing a non-transitory computer-readable storage medium storing a machine learning model, the machine learning model being used for anomaly detection detecting an anomaly in an object including a normal object and an anomalous object containing the anomaly, the machine learning model including an encoder configured to generate feature data for the object in response to captured image data obtained by capturing an image of the object being inputted, the encoder including a convolutional neural network, the method comprising:
training the encoder using training image data, the training image data being obtained by performing a specific image process on original image data, the original image data being obtained by capturing an image of the object,
wherein the anomaly detection includes:
generating image data for feature extraction by executing a first adjustment process on the original image data, the image data for feature extraction representing an image of the normal object;
generating feature data for the normal object by inputting the image data for feature extraction into the machine learning model that has been trained; and
detecting an anomaly in an inspection object using the feature data for the normal object and feature data for the inspection object.

15. The method according to claim 14,
wherein the training image data is normal image data representing an image of the normal object,
wherein the training configures an image generation model including the encoder and a decoder, the decoder being configured to generate output image data using data outputted from the encoder, and
wherein the training is performed such that when the training image data is inputted into the encoder, the output image data generated by the decoder reproduces the training image data.

16. The method according to claim 14,
wherein the training image data includes first image data representing an image of the normal object and second image data representing an image of the anomalous object,
wherein the training configures an image recognition model configured to generate output data indicating a recognition result of an image using data outputted from the encoder, and
wherein the training is performed such that when the training image data is inputted into the encoder, the output data identifies whether the training image data is the first image data or the second image data.

17. The method according to claim 16,
wherein the specific image process includes a first image process and a second image process, the first image process adjusting an image attribute that is variable due to variations in factors other than a defect that should be identified as the anomaly, the second image process adding a pseudo-defect that should be identified as the anomaly to an image, and
wherein by executing the second image process M times on one set of the first image data generated through a single execution of the first image process, M sets of the second image data are generated, where M is an integer greater than or equal to two.

18. The method according to claim 16,
wherein the specific image process includes a first image process and a second image process, the first image process adjusting an image attribute that is variable due to variations in factors other than a defect that should be identified as the anomaly, the second image process adding a pseudo-defect that should be identified as the anomaly to an image, and
wherein by executing the second image process m times on each of n sets of the first image data, (n×m) sets of the second image data are generated, where m is an integer greater than or equal to one, and n is an integer greater than or equal to two.

19. The method according to claim 14,
wherein the first adjustment process adjusts an image attribute that is variable due to variations in factors other than a defect that should be identified as the anomaly,
wherein the specific image process includes a second adjustment process adjusting the image attribute, and
wherein a maximum adjustment amount of the image attribute in the second adjustment process is greater than a maximum adjustment amount of the image attribute in the first adjustment process.

20. The method according to claim 14,
wherein the object is a label affixed to a product.

21. A non-transitory computer-readable storage medium storing a set of computer-readable instructions for performing anomaly detection with a machine learning model, the anomaly detection detecting an anomaly in an object including a normal object and an anomalous object containing the anomaly, the machine learning model including an encoder configured to generate feature data for the object in response to captured image data obtained by capturing an image of the object being inputted, the encoder including a convolutional neural network, the set of computer-readable instructions, when executed by a computer, causing the computer to perform:
generating image data for feature extraction by executing a first adjustment process on original image data, the original image data being obtained by capturing an image of the object, the image data for feature extraction representing an image of the normal object;
generating feature data for the normal object by inputting the image data for feature extraction into the machine learning model that has been trained; and
detecting an anomaly in an inspection object using the feature data for the normal object and feature data for the inspection object.

22. A method of detecting an anomaly in an object with a machine learning model, the object including a normal object and an anomalous object containing the anomaly, the machine learning model including an encoder configured to generate feature data for the object in response to captured image data obtained by capturing an image of the object being inputted, the encoder including a convolutional neural network, the method comprising:
training the encoder using training image data;
generating feature data for the normal object by inputting image data for feature extraction into the encoder trained in the training; and
detecting an anomaly in an inspection object using the feature data for the normal object and feature data for the inspection object,
wherein at least one of the training image data and the image data for feature extraction is obtained by executing a specific process on original image data, the original image data being obtained by capturing an image of the object.
